(19) United States
(12) Patent Application Publication
(10) Pub. No.: US 2020/0234678 A1
(43) Pub. Date: Jul. 23, 2020

(54) IMAGE DISPLAYING DEVICE AND INPUT DEVICE AND COMPUTING DEVICE WITH SAME

(71) Applicant: Primax Electronics Ltd., Taipei (TW)

(72) Inventors: Hui-Ling Lin, Taipei (TW); Yu-Zeng Yang, Taipei (TW)

(21) Appl. No.: 16/393,687

(22) Filed: Apr. 24, 2019

(30) Foreign Application Priority Data
Jan. 18, 2019 (TW) 108102046

(51) Int. Cl. G09G 5/14; G09G 5/00; G06F 3/0354; G06F 3/02; G09G 5/10

(52) U.S. Cl. CPC G09G 5/14; G09G 5/003; G06F 3/03543; G09G 2320/0626; G09G 5/10; G09G 2320/0666; G06F 3/0202

(57) ABSTRACT

An image displaying device includes a grating plate, a light source module, plural image regions and a support structure. The grating plate and the light source module are supported by the support structure. The plural image regions are arranged between the light source module and the plural lenses. After each of the plural light beams passes through the corresponding image region, the light beam is guided by the grating plate and outputted. Consequently, the image changed with the user's viewpoint and/or the three-dimensional image can be shown on the mouse device. An input device and a computing device with the image displaying device are also provided.

### FIELD OF THE INVENTION

The present invention relates to an image displaying field, and more particularly to an image displaying device and an input device and a computing device with the image displaying device.

### BACKGROUND OF THE INVENTION

Generally, images (e.g., logo images) are formed on electronic devices through a printing process, a hot pressing process or stickers. After the images are formed on the electronic devices, the images cannot be changed. For solving this drawback, an electronic device with a projection function has been disclosed. Hereinafter, a mouse device is taken as an example of the electronic device for illustration.

Please refer to FIGS. 1 and 2. FIG. 1 is a schematic perspective view illustrating the appearance of a conventional mouse device. FIG. 2 schematically illustrates the concepts of the projecting function of the mouse device as shown in FIG. 1. The conventional mouse device 1 comprises a casing 11, left/right buttons 12, a LCD panel 13, a microcontroller (not shown), a magnifying lens 14, a projection light source 15 and a light-transmissible projection panel 16. The left/right buttons 12 are exposed outside the casing 11 so as to be operated by the user. The microcontroller, the LCD panel 13 and the projection light source 15 are accommodated within the casing 11. Moreover, the microcontroller is electrically connected with the LCD panel 13. The light-transmissible projection panel 16 is installed on the casing 11 and located at a focusing position of the magnifying lens 14. The image shown on the LCD panel 13 is controlled by the microcontroller. The projection light source 15 emits a light beam to the LCD panel 13. When the associated information is shown on the LCD panel 13 under control of the microcontroller and in response to the light beam from the projection light source 15, the image shown on the LCD panel 13 is enlarged by the magnifying lens 14. The enlarged image is projected onto the light-transmissible projection panel 16 so as to be viewed by the user. The technology of the mouse device 1 is disclosed in Taiwanese Utility Model No. TWM385747, which is entitled “Projection mouse” and detailed descriptions thereof are omitted.

As mentioned above, the input device is equipped with the LCD panel to provide the projecting function. However, the installation of the LCD panel increases the fabricating cost of the input device. Moreover, the bulky volume of the LCD panel is detrimental to the development of the input device toward light weightiness, slimness and small size.

### SUMMARY OF THE INVENTION

An object of the present invention provides an image displaying device comprising plural image regions. The backlight source provides plural light beams. After the plural light beams pass through the plural image regions, the light beams are guided by the grating plate and outputted to the outside. Consequently, the image changed with the user's viewpoint and/or the three-dimensional image can be shown on the mouse device.

Another object of the present invention provides an input device comprising the image displaying device. Since the image displaying device is cost-effective and small, the fabricating cost of the input device is reduced and the purpose of developing the input device toward light weightiness, slimness and small size is achieved.

A further object of the present invention provides a computing device comprising the image displaying device. Since the image displaying device is cost-effective and small, the fabricating cost of the computing device is reduced and the purpose of developing the computing device toward light weightiness, slimness and small size is achieved.

In accordance with an aspect of the present invention, an input device is provided. The input device includes a processing unit, an image displaying device and a casing. The processing unit is in communication with a computing device. When the input device is operated by a user, the processing unit generates a control signal to the computing device. The image displaying device includes a grating plate, a light source module, plural image regions and a support structure. The grating plate includes plural lenses. The light source module provides plural light beams. The plural image regions are arranged between the light source module and the plural lenses. The grating plate and the light source module are supported by the support structure. After each of the plural light beams passes through the corresponding image region, the light beam is guided by the corresponding lens and outputted. The processing unit and at least a portion of the image displaying device are accommodated within the casing.

In accordance with another aspect of the present invention, a computing device is provided. The computing device includes a processing unit, an image displaying device and a casing. When the computing device is operated by a user, the processing unit generates a control unit. The image displaying device includes a grating plate, a light source module, plural image regions and a support structure. The grating plate includes plural lenses. The light source module provides plural light beams. The plural image regions are arranged between the light source module and the plural lenses. The grating plate and the light source module are supported by the support structure. After each of the plural light beams passes through the corresponding image region, the light beam is guided by the corresponding lens and outputted. The processing unit and at least a portion of the image displaying device are accommodated within the casing.

In accordance with another aspect of the present invention, an image displaying device is provided. The image displaying device includes a grating plate, a light source module, plural image regions and a support structure. The grating plate includes plural lenses. The light source module provides plural light beams. The plural image regions are arranged between the light source module and the plural lenses. After each of the plural light beams passes through the corresponding image region, the light beam is guided by the corresponding lens and outputted. The grating plate and the light source module are supported by the support structure.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the appearance of a conventional mouse device;

FIG. 2 schematically illustrates the concepts of the projecting function of the mouse device as shown in FIG. 1;

FIG. 3 is a schematic side view illustrating the concepts of an image displaying device according to an embodiment of the present invention;

FIG. 4 is a schematic exploded view illustrating the image displaying device as shown in FIG. 3;

FIG. 5 schematically illustrates the operating concepts of the image displaying device as shown in FIG. 3;

FIG. 6 schematically illustrates the operating concepts of an image displaying device according to a second embodiment of the present invention;

FIG. 7 is a schematic exploded view illustrating an image displaying device according to a third embodiment of the present invention;

FIG. 8 is a schematic perspective view illustrating the appearance of an input device according to an embodiment of the present invention; and

FIG. 9 is a schematic perspective view illustrating the appearance of a computing device according to an embodiment of the present invention.

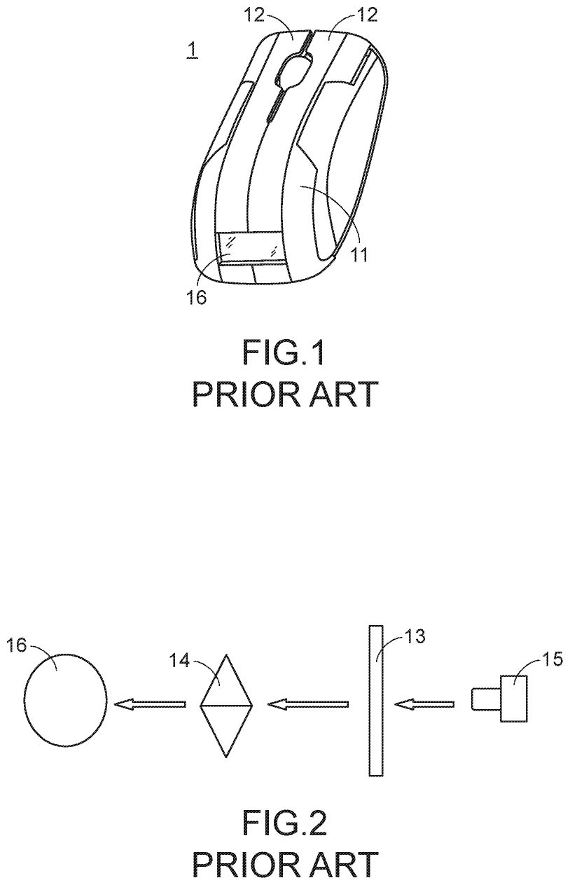

### DETAILED DESCRIPTION OF THE PREFERRED EMBODIMENT

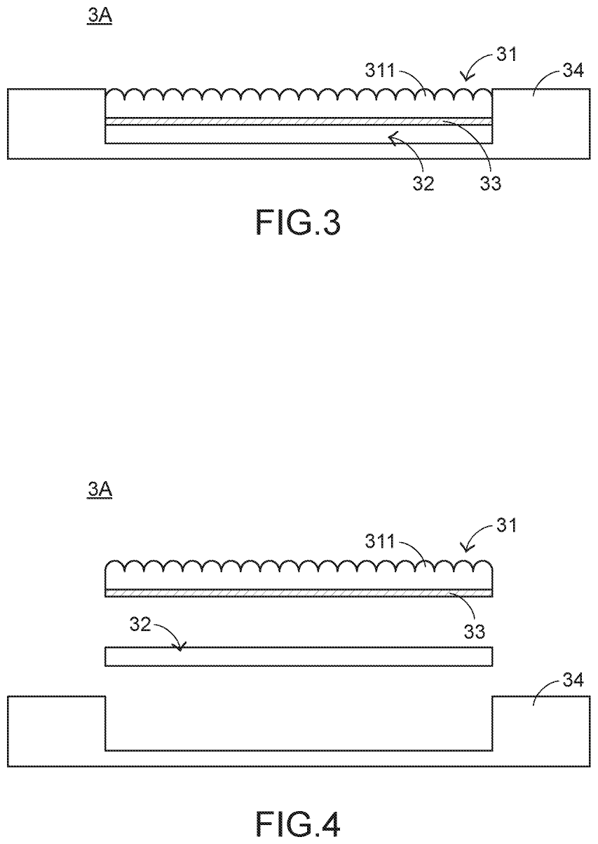

Please refer to FIGS. 3 and 4. FIG. 3 is a schematic side view illustrating the concepts of an image displaying device according to an embodiment of the present invention. FIG. 4 is a schematic exploded view illustrating the image displaying device as shown in FIG. 3. The image displaying device 3A comprises a grating plate 31, a light source module 32, an image layer 33 and a support structure 34.

The grating plate 31 and the light source module 32 are supported by the support structure 34. Moreover, plural lenses 311 are formed on a first surface of the grating plate 31. The image layer 33 is arranged between the light source module 32 and the plural lenses 311. In this embodiment, a second surface of the grating plate 31 is a flat surface. The second surface of the grating plate 31 is opposed to the first surface of the grating plate 31. The image layer 33 is disposed on the second surface of the grating plate 31. Preferably but not exclusively, the image layer 33 is disposed on the second surface of the grating plate 31 by a printing process.

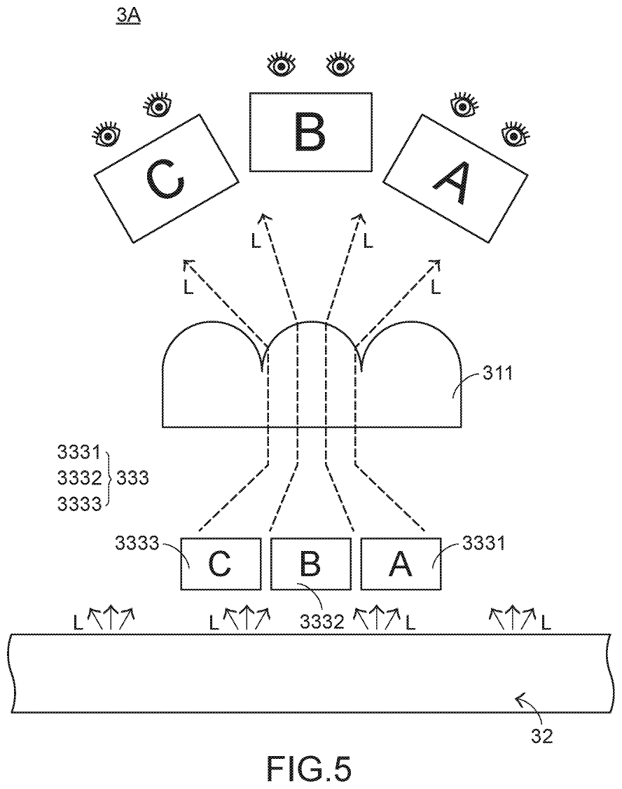

FIG. 5 schematically illustrates the operating concepts of the image displaying device as shown in FIG. 3. The light source module 32 provides plural light beams L. After each light beam L of the plural light beams L passes through the image layer 33, the light beam L is guided by the corresponding lens 311 of the grating plate 31 and then outputted to the outside. In an embodiment, the image layer 33 comprises plural image regions 333. These image regions 333 include a first image region 3331, a second image region 3332 and a third image region 3333. After the light beam L passes through the first image region 3331, the light beam L is guided by the corresponding lens 311 of the grating plate 31 and then outputted to the outside. Consequently, when the image displaying device 3A is viewed by the user from a first viewpoint, the image corresponding to the first image region 3331 is viewable by the user. After the light beam L passes through the second image region 3332, the light beam L is guided by the corresponding lens 311 of the grating plate 31 and then outputted to the outside. Consequently, when the image displaying device 3A is viewed by the user from a second viewpoint, the image corresponding to the second image region 3332 is viewable by the user. After the light beam L passes through the third image region 3333, the light beam L is guided by the corresponding lens 311 of the grating plate 31 and then outputted to the outside. Consequently, when the image displaying device 3A is viewed by the user from a third viewpoint, the image corresponding to the third image region 3333 is viewable by the user.

As mentioned in FIG. 5, the images corresponding to different image regions 333 can be viewed by the user when the image displaying device 3A is viewed by the user from different viewpoints. In an embodiment, the images corresponding to these image regions 333 have the relationship corresponding to the successive motions. For example, these image regions 333 are correlated to successive images corresponding to a running animal. When the user sequentially views the image displaying device 3A from different viewpoints, the animation formed by the images corresponding to the image regions 333 can be viewed. In another embodiment, the images corresponding to these image regions 333 have the three-dimensional relationship. For example, these image regions 333 indicate the images of a scene or object to be viewed by the left eye and the right eye of the human. When the user views the image displaying device 3A with both of the left eye and the right eye, a three-dimensional image can be viewed.

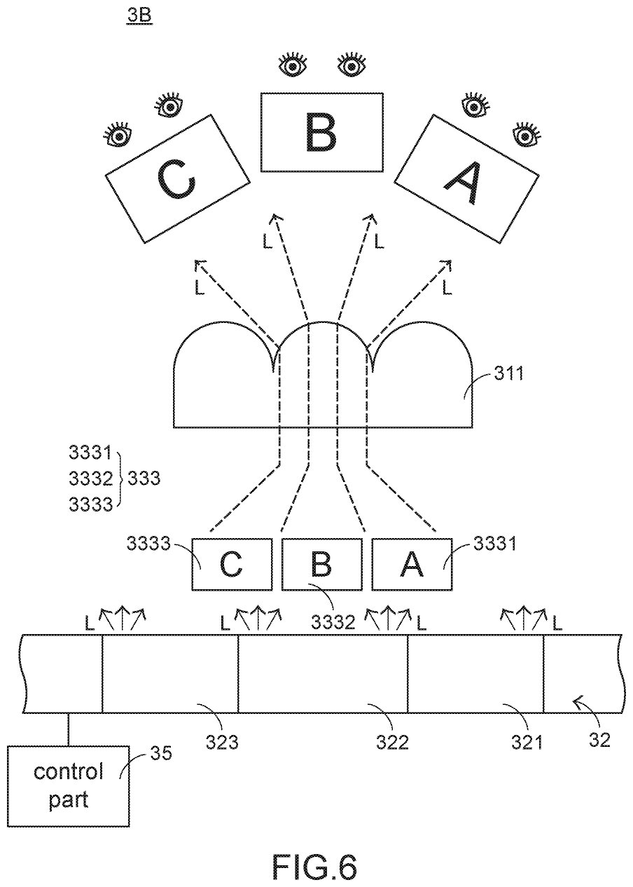

FIG. 6 schematically illustrates the operating concepts of an image displaying device according to a second embodiment of the present invention. The structures and functions of the components of the image displaying device 3B which are identical to those of the first embodiment are not redundantly described herein. In comparison with the first embodiment, the image displaying device 3B further comprises a control part 35. The control part 35 is electrically connected with the light source module 32 for driving the light source module 32 to provide the plural light beams L. The light source module 32 comprises plural light-emitting elements. Under the control of the control part 35, each light-emitting element emits a light beam L with a specified brightness value and/or a specified color according to a specified time sequence. Then, the light beam L passes through the image layer 33.

In this embodiment, the light source module 32 comprises a first light-emitting element 321, a second light-emitting element 322 and a third light-emitting element 323 corresponding to the first image region 3331, the second image region 3332 and the third image region 3333, respectively. According to the practical requirements, the control part 35 controls the first light-emitting element 321, the second light-emitting element 322 and the third light-emitting element 323 to emit the light beams L. Consequently, the images corresponding to the first image region 3331 with the first color and the first brightness value, the second image region 3332 with the second color and the second brightness value and the third image region 3333 with the third color and the third brightness value are shown on the image displaying device 3B. Under the control of the control part 35, the images corresponding to any two of the first image region 3331, the second image region 3332 and the third image region 3333 are simultaneously or alternatively shown. Moreover, under the control of the control part 35, any two colors of the first color, the second color and the third color may be identical or different, and any two brightness values of the first brightness value, the second brightness value and the third brightness value may be identical or different.

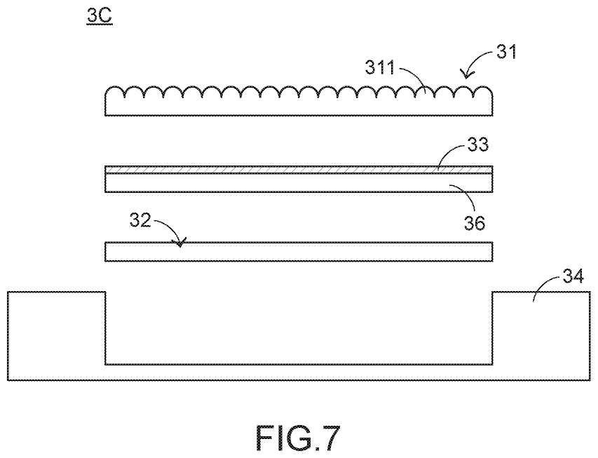

FIG. 7 is a schematic exploded view illustrating an image displaying device according to a third embodiment of the present invention. The structures and functions of the components of the image displaying device 3C which are identical to those of the first embodiment and the third embodiment are not redundantly described herein. In comparison with the first embodiment and the second embodiment, the image displaying device 3C further comprises a substrate 36. The substrate 36 is arranged between the grating plate 31 and the light source module 32. The image layer 33 is disposed on the substrate 36. At least a portion of the substrate 36 is light-transmissible. The substrate 36 is made of a flexible plastic material, a glassy material, a metallic material or any other appropriate hard material. The image layer 33 is printed on a top surface or a bottom surface of the substrate 36. It is noted that the material of the substrate 36 and the way of forming the image layer 33 are not restricted.

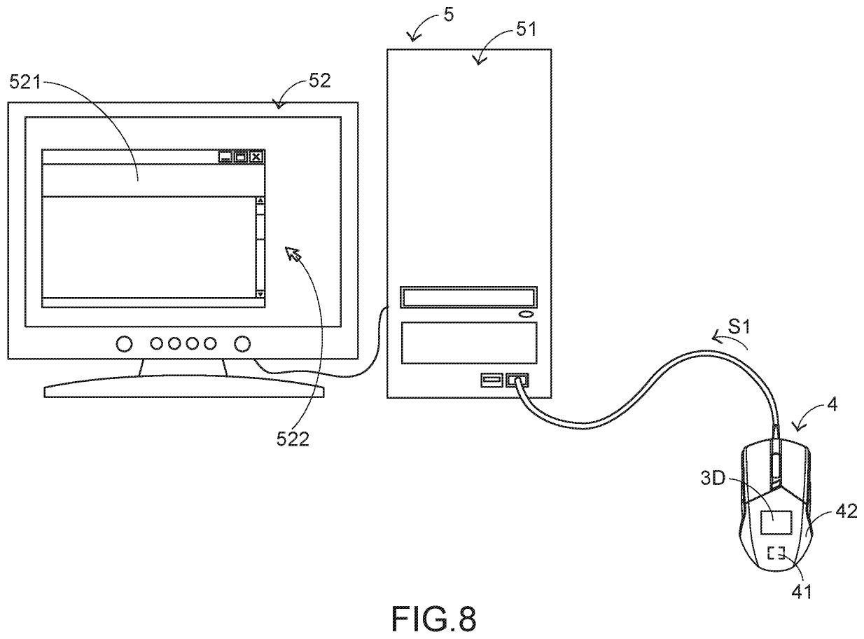

FIG. 8 is a schematic perspective view illustrating the appearance of an input device according to an embodiment of the present invention. In this embodiment, the input device is a mouse device 4. The mouse device 4 comprises a processing unit 41, an image displaying device 3D and a casing 42. The processing unit 41 and at least a portion of the image displaying device 3D are accommodated within the casing 42. The mouse device 4 is connected with a hot 51 of a computing device 5. The processing unit 41 is in communication with the host 51. In FIG. 8, the mouse device 4 is connected with the host 51 in a wired transmission manner. Alternatively, the mouse device is connected with the host in a wireless transmission manner. A cursor 522 and a graphic-based window 521 are displayed on a monitor 52 of the computing device 5. When the user's palm holds the mouse device 4 to operate the mouse device 4, the processing unit 41 generates a control signal S1 to the host 51 according to the displacement amount of the mouse device 4. According to the control signal S1, the cursor 522 shown on the monitor 52 is correspondingly moved.

The image displaying device 3D of the mouse device 4 is similar to the image displaying device 3A, 3B or 3C. Consequently, the image changed with the user's viewpoint and/or the three-dimensional image can be shown on the mouse device. In the above embodiment, the input device is the mouse device. It is noted that numerous modifications and alterations may be made while retaining the teachings of the invention. For example, in another embodiment, the input device is a keyboard device.

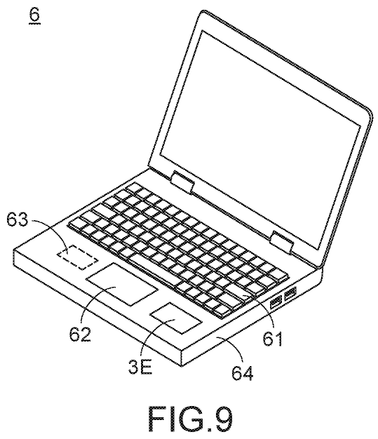

FIG. 9 is a schematic perspective view illustrating the appearance of a computing device according to an embodiment of the present invention. In this embodiment, the computing device 6 is a notebook computer. The notebook computer 6 comprises a keyboard 61, a touchpad 62, a processing unit 63, an image displaying device 3E and a casing 64. The processing unit 63 and at least a portion of the image displaying device 3E are accommodated within the casing 64. The keyboard 61 or the touchpad 62 can be operated by the user. When the user operates the keyboard 61 or the touchpad 62, the processing unit 63 generates a control signal to control the notebook computer 6.

The image displaying device 3E of the notebook computer 6 is similar to the image displaying device 3A, 3B or 3C. Consequently, the image changed with the user's viewpoint and/or the three-dimensional image can be shown on the notebook computer 6. In the above embodiment, the computing device is the notebook computer. It is noted that numerous modifications and alterations may be made while retaining the teachings of the invention. For example, in another embodiment, the computing device is a tablet computer or a portable electronic device.

From the above descriptions, the image displaying device of the present invention comprises plural image regions. The backlight source provides plural light beams. After the plural light beams pass through the plural image regions, the light beams are guided by the grating plate and outputted to the outside. Consequently, the image changed with the user's viewpoint and/or the three-dimensional image can be shown on the mouse device. Since the image displaying device is cost-effective and small, the fabricating cost of the input device or the computing device with the image displaying device is reduced. In addition, the purpose of developing the input device or the computing device toward light weightiness, slimness and small size is achieved.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An input device, comprising:
a processing unit in communication with a computing device, wherein when the input device is operated by a user, the processing unit generates a control signal to the computing device;
an image displaying device comprising a grating plate, a light source module, plural image regions and a support structure, wherein the grating plate comprises plural lenses, the light source module provides plural light beams, the plural image regions are arranged between the light source module and the plural lenses, and the grating plate and the light source module are supported by the support structure, wherein after each of the plural light beams passes through the corresponding image region, the light beam is guided by the corresponding lens and outputted; and
a casing, wherein the processing unit and at least a portion of the image displaying device are accommodated within the casing.

2. The input device according to claim 1, wherein the plural lenses are formed on a first surface of the grating plate, and the plural image regions are formed on a second surface of the grating plate, wherein the first surface and the second surface of the grating plate are opposed to each other.

3. The input device according to claim 1, wherein the image displaying device further comprises a substrate, wherein the substrate is arranged between the grating plate and the light source module, and the plural image regions are disposed on the substrate.

4. The input device according to claim 1, wherein the image displaying device further comprises a control part, wherein the control part is electrically connected with the light source module, and the light source module is driven to provide the plural light beams under control of the control part.

5. The input device according to claim 4, wherein the light source module comprises at least one light-emitting element, wherein under control of the control part, each of the at least one light-emitting element emits a light beam with a specified brightness value and/or a specified color according to a specified time sequence.

6. The input device according to claim 1, wherein the input device is a mouse device or a keyboard device.

7. A computing device, comprising:
a processing unit, wherein when the computing device is operated by a user, the processing unit generates a control unit;
an image displaying device comprising a grating plate, a light source module, plural image regions and a support structure, wherein the grating plate comprises plural lenses, the light source module provides plural light beams, the plural image regions are arranged between the light source module and the plural lenses, and the grating plate and the light source module are supported by the support structure, wherein after each of the plural light beams passes through the corresponding image region, the light beam is guided by the corresponding lens and outputted; and
a casing, wherein the processing unit and at least a portion of the image displaying device are accommodated within the casing.

8. The computing device according to claim 7, wherein the plural lenses are formed on a first surface of the grating plate, and the plural image regions are formed on a second surface of the grating plate, wherein the first surface and the second surface of the grating plate are opposed to each other.

9. The computing device according to claim 7, wherein the image displaying device further comprises a substrate, wherein the substrate is arranged between the grating plate and the light source module, and the plural image regions are disposed on the substrate.

10. The computing device according to claim 7, wherein the image displaying device further comprises a control part, wherein the control part is electrically connected with the light source module, and the light source module is driven to provide the plural light beams under control of the control part.

11. The computing device according to claim 10, wherein the light source module comprises at least one light-emitting element, wherein under control of the control part, each of the at least one light-emitting element emits a light beam with a specified brightness value and/or a specified color according to a specified time sequence.

12. An image displaying device, comprising:
a grating plate comprising plural lenses;
a light source module providing plural light beams;
plural image regions arranged between the light source module and the plural lenses, wherein after each of the plural light beams passes through the corresponding image region, the light beam is guided by the corresponding lens and outputted; and
a support structure, wherein the grating plate and the light source module are supported by the support structure.

13. The image displaying device according to claim 12, wherein the plural lenses are formed on a first surface of the grating plate, and the plural image regions are formed on a second surface of the grating plate, wherein the first surface and the second surface of the grating plate are opposed to each other.

14. The image displaying device according to claim 12, wherein the image displaying device further comprises a substrate, wherein the substrate is arranged between the grating plate and the light source module, and the plural image regions are disposed on the substrate.

15. The image displaying device according to claim 12, wherein the image displaying device further comprises a control part, wherein the control part is electrically connected with the light source module, and the light source module is driven to provide the plural light beams under control of the control part.

16. The image displaying device according to claim 15, wherein the light source module comprises at least one light-emitting element, wherein under control of the control part, each of the at least one light-emitting element emits a light beam with a specified brightness value and/or a specified color according to a specified time sequence.

17. The image displaying device according to claim 12, wherein an image corresponding to a first image region of the plural image regions is viewable by a user from a first viewpoint, and an image corresponding to a second image region of the plural image regions is viewable by the user from a second viewpoint.

18. The image displaying device according to claim 12, wherein a three-dimensional image is outputted from the image displaying device according to the plural image regions.
